(19) United States
(12) Patent Application Publication
(10) Pub. No.: US 2017/0011566 A1
(43) Pub. Date: Jan. 12, 2017

(54) FAULT DIAGNOSIS APPARATUS AND METHOD FOR VEHICLE ACCESSORIES

(71) Applicant: HYUNDAI MOTOR COMPANY, Seoul (KR)

(72) Inventor: Sang Kyu WOO, Yongin-si (KR)

(73) Assignee: HYUNDAI MOTOR COMPANY, Seoul (KR)

(21) Appl. No.: 14/939,824

(22) Filed: Nov. 12, 2015

(30) Foreign Application Priority Data
Jul. 7, 2015 (KR) 10-2015-0096556

(51) Int. Cl. G07C 5/08; B60K 25/02

(52) U.S. Cl. CPC G07C 5/0808; G07C 5/0816; B60K 25/02; B60K 2025/022

(57) ABSTRACT

The present disclosure provides a fault diagnosis apparatus and method for vehicle accessories capable of effectively diagnosing a fault of vehicle accessories driven by a vehicle accessory driving device. The fault diagnosis apparatus for vehicle accessories includes a damper pulley installed at a crank shaft of an engine, and a torque detection unit installed at the damper pulley and detecting torque of the damper pulley in real time.

### CROSS-REFERENCE TO RELATED APPLICATION

This application claims the benefit of the Korean Patent Application No. 10-2015-0096556, filed on Jul. 7, 2015, which is incorporated herein by reference in its entirety.

### FIELD

The present disclosure relates to a fault diagnosis apparatus and method for vehicle accessories.

### BACKGROUND

The statements in this section merely provide background information related to the present disclosure and may not constitute prior art.

A vehicle accessory driving device is configured to drive a plurality of vehicle accessories such as a water pump, an air-conditioning compressor, and an alternator by power of an engine.

The water pump serves to forcibly circulate a coolant to the interior of an engine to prevent the engine from being overheated, the air conditioning compressor serves to compress a refrigerant to air-conditioning an indoor area, and the alternator serves to produce electricity required for driving a vehicle to charge a battery.

The vehicle accessory driving device includes a damper pulley (crank pulley) provided at a crank shaft of an engine, a plurality of vehicle accessory pulleys provided at each of vehicle accessories (the water pump, the air-conditioning compressor, and the alternator), a belt wound between the damper pulley and the vehicle accessory pulleys, and a tensioner providing tensile force to the belt. As a crank shaft of the engine rotates, a plurality of vehicle accessories are driven.

When a vehicle accessory has a fault, various problems arise as follows. For example, when the alternator has a fault, the battery may not be smoothly charged. When the water pump has a fault, a temperature of a coolant is increased due to overheating of the engine. When the air-conditioning compressor has a fault, cooling or heating performance of an indoor area is degraded. Also, a fault of each of the vehicle accessories may lead to generation of a fault of the belt or the tensioner of the vehicle accessory driving device.

We have discovered that a vehicle accessory driving device, when each of the vehicle accessories or the belt has a fault, cannot effectively diagnose the fault before various problems as mentioned above are manifested due to the fault of each of the vehicle accessories.

### SUMMARY

The present disclosure provides a fault diagnosis apparatus and method for vehicle accessories, capable of effectively diagnosing a fault of vehicle accessories of an engine by monitoring in real time a torque generated in the course of driving a plurality of vehicle accessories connected to a crank shaft of the engine by an vehicle accessory driving device.

According to an exemplary embodiment of the present disclosure, a fault diagnosis apparatus for vehicle accessories includes: a damper pulle; and a torque detection unit installed at the damper pulley and configured to detect torque of the damper pulley in real time.

The torque detection unit may include at least one strain gauge installed at the damper pulley side to gauge strain of the damper pulley.

The torque detection unit may further include: a fault diagnosis part connected to the at least one strain gauge, wherein the fault diagnosis part may be configured to calculate the strain of the damper pulley gauged by the at least one strain gauge, as a torque value.

According to another exemplary embodiment of the present disclosure, a fault diagnosis apparatus for vehicle accessories, to diagnose a fault of at least one vehicle accessory by detecting torque generated in a damper pulley as the at least one vehicle accessory is driven, includes: a torque detection unit configured to have at least one strain gauge installed at the damper pulley to detect torque; and an installation portion configured to protrude outwardly from the damper pulley and allow the at least one strain gauge to be installed thereon.

The installation portion may be protruded outwardly from a hub of the damper pulley.

The installation portion may include a coupling flange coupled to the hub of the damper pulley, a first cylindrical portion configured to extend so as to protrude outwardly from the coupling flange, and a second cylindrical portion disposed in parallel inside the first cylindrical portion.

The first cylindrical portion may extend to protrude outwardly from the center of the coupling flange, and the second cylindrical portion may be disposed to be radially spaced apart by a predetermined gap from an inner circumferential surface of the first cylindrical portion.

The at least one strain gauge may be installed on the outer circumferential surface of the first cylindrical portion.

The at least one strain gauge may be installed to have a full bridge structure on an outer circumferential surface of the first cylindrical portion.

A thickness of the first cylindrical portion may be smaller than that of the second cylindrical portion.

One end of the first cylindrical portion may be connected to one end of the second cylindrical portion through a connection portion, and a boss, to which the crank shaft of the engine is coupled, may be provided at the other end of the second cylindrical portion.

According to another exemplary embodiment of the present disclosure, a fault diagnosis method for vehicle accessories, to diagnose a fault of at least one vehicle accessory by detecting torque generated in a damper pulley as the at least one vehicle accessory is driven, includes: detecting torque of the damper pulley; when the detected torque is outside a range of normal torque, comparing a temperature of an engine coolant with a preset value; and when the temperature of the engine coolant is higher than the preset value, diagnosing a fault of a water pump among the at least one vehicle accessory.

The method may further include: when the temperature of the engine coolant is lower than the preset value, diagnosing a fault of a vehicle accessory other than the water pump among the at least one vehicle accessory and warning about the fault of the vehicle accessory.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating an example of a vehicle accessory driving device to which a fault diagnosis apparatus for vehicle accessories according to the present disclosure is applied;

FIG. 2 is a partially cutaway perspective view illustrating a state in which a fault diagnosis apparatus for vehicle accessories according to the present disclosure is installed at a damper pulley of a vehicle accessory driving device;

FIG. 3 is an enlarged view illustrating a portion “A” indicated by the arrows of FIG. 2;

FIG. 4 is a block diagram illustrating a torque detection unit of a fault diagnosis apparatus for vehicle accessories according to the present disclosure;

FIG. 5 is a graph illustrating normal transmission torque of a damper pulley according to selective operation modes of vehicle accessories and an RPM of an engine; and

FIG. 6 is a flow chart illustrating a fault diagnosis method for vehicle accessories using a fault diagnosis apparatus for vehicle accessories according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

For reference, dimensions of elements or thicknesses of lines illustrated in the drawings referred to describe the present disclosure may be exaggerated for the convenience of understanding. Also, the terms used henceforth have been defined in consideration of the functions of the present disclosure, and may be altered according to the intent of a user or operator, or conventional practice. Therefore, the terms should be defined on the basis of the entire content of this specification.

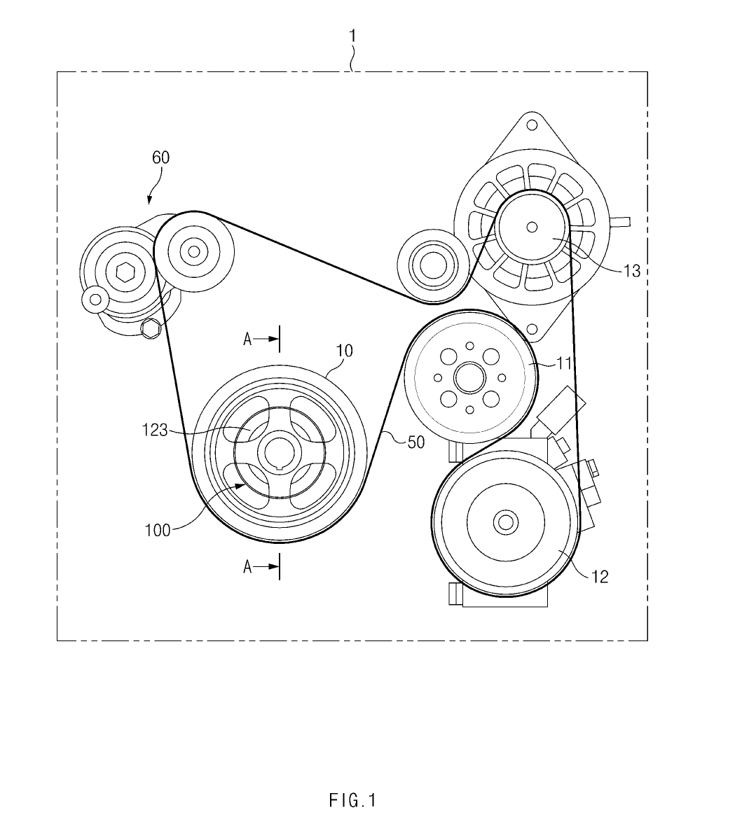

FIG. 1 is a view illustrating an example of a vehicle accessory driving device to which a fault diagnosis apparatus for vehicle accessories according to the present disclosure is applied. The vehicle accessory driving device includes a damper pulley 10 installed at a crank shaft of an engine 1, a plurality of vehicle accessory pulleys 11, 12, and 13 installed at each of vehicle accessories, a belt 50 wound around the damper pulley 10 and the plurality of vehicle accessory pulleys 11, 12, and 13, and a tensioner 60 providing tensile force to the belt 50.

When the damper pulley 10 is driven according to driving of the engine 1, the plurality of vehicle accessory pulleys 11, 12, and 13 are rotated through the belt 50. For example, the damper pulley 10 is a driving pulley driving the plurality of vehicle accessory pulleys 11, 12, and 13, and the plurality of vehicle accessory pulleys 11, 12, and 13 are driven pulleys driven by the damper pulley 10.

The plurality of vehicle accessory pulleys 11, 12, and 13 may include a first vehicle accessory pulley 11 which may drive the water pump, a second vehicle accessory pulley 12 driving the air-conditioning compressor, and a third vehicle accessory pulley 13 driving the alternator.

A clutch (not shown) may be installed between shafts of the vehicle accessories and the vehicle accessory pulleys 11, 12, and 13. According to coupling and releasing of the clutch (not shown), rotational force of the vehicle accessory pulleys 11, 12, and 13 may be selectively transmitted to the vehicle accessories, and accordingly, the vehicle accessories may be selectively operated according to rotations of the vehicle accessory pulleys 11, 12, and 13.

When the vehicle accessories operate, torque is generated in the corresponding vehicle accessory pulleys 11, 12, and 13, and the torque generated in the vehicle accessory pulleys 11, 12, and 13 is transmitted to the damper pulley 10 through the belt 50. For example, torque of the corresponding vehicle accessory pulleys 11, 12, and 13 may be transmitted to the damper pulley 10 according to whether the vehicle accessories operate, and whether each of the vehicle accessories has a fault may be effectively diagnosed by detecting torque of the damper pulley 10 in real time.

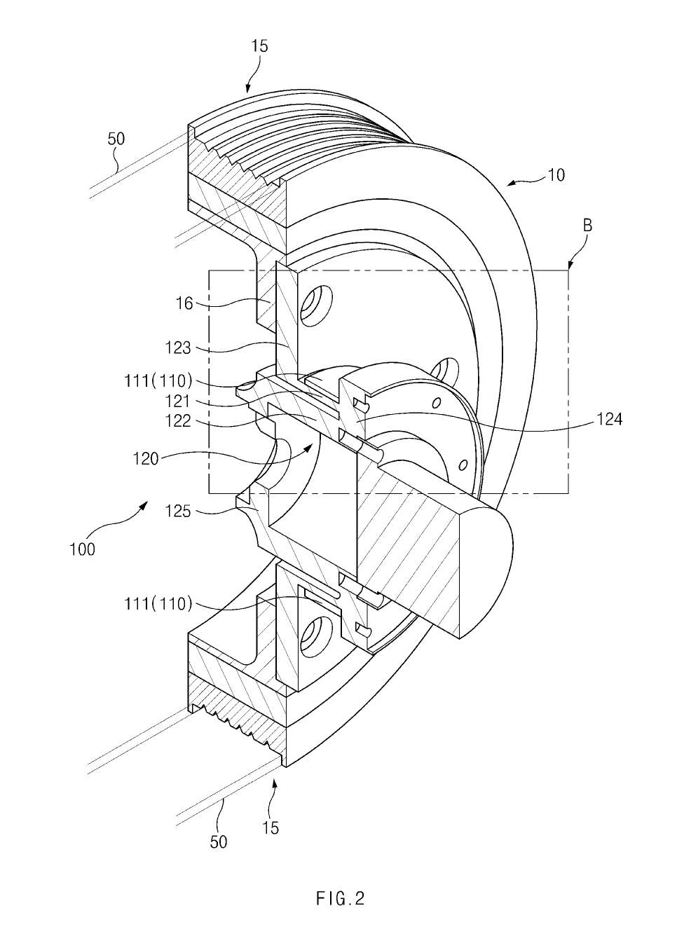

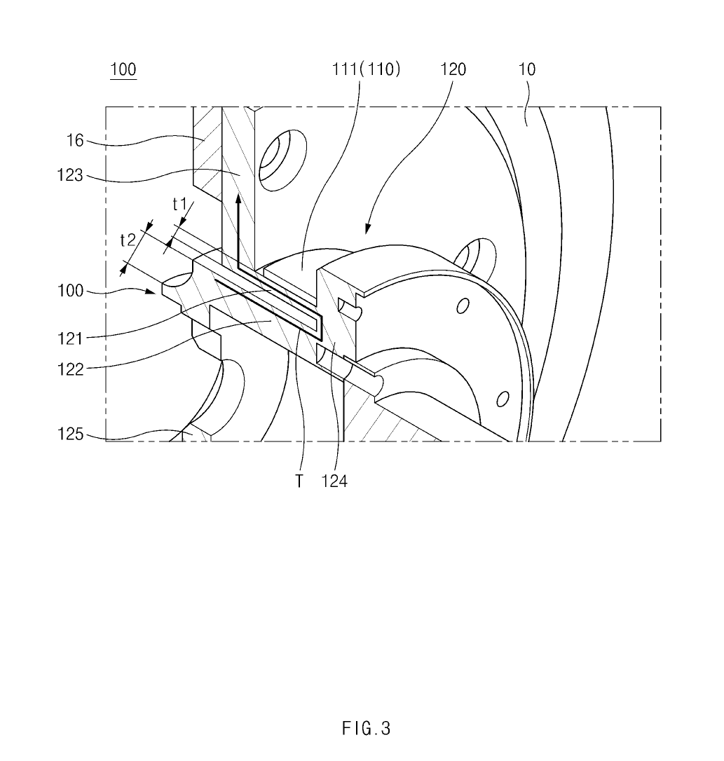

As illustrated in FIGS. 2 and 3, the fault diagnosis apparatus 100 for vehicle accessories according to an exemplary embodiment of the present disclosure includes a torque detection unit 110 installed at the damper pulley 10 to detect torque.

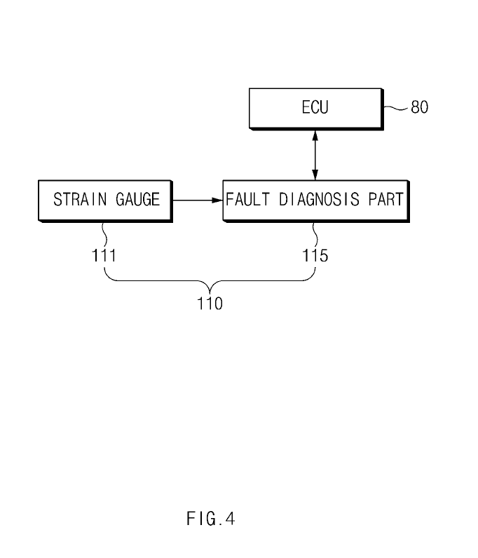

As illustrated in FIGS. 2 through 4, the torque detection unit 110 includes one or more strain gauges 111 installed at one side of the damper pulley 10 to gauge deformation of the damper pulley 10, and a fault diagnosis part 115 connected to the strain gauge 111.

The strain gauge 111 is configured to detect torque of the damper pulley 10 by gauging strain due to torque generated in the damper pulley 10.

The fault diagnosis part 115 is configured to calculate the strain of the damper pulley 10 gauged by the strain gauge 111, as a torque value. Also, the fault diagnosis part 115 may be connected to an electric control unit (ECU) 80 of a vehicle to receive various types of information of the vehicle accessories from the ECU 80. Thus, since the fault diagnosis part 115 calculates the strain gauged by the strain gauge 111, as a torque value, and receives information of the vehicle accessories from the ECU 80, it may effectively diagnoses a fault of the vehicle accessories.

A recess portion 15 around which the belt 50 is wound is formed on an outer circumferential surface of the damper pulley 10, and a hub 16 is provided inside the damper pulley 10.

The strain gauge 111 of the torque detection unit 110 is installed on an installation portion 120 outwardly protruding from the damper pulley 10. Thus, since the strain gauge 111 may be installed in a position protruding outwardly from the damper pulley 10 and the strain gauge 111 may not be affected by tensile force of the belt 50 in the damper pulley 10, strain or torque of the damper pulley 10 may be more accurately detected.

The aforementioned installation portion 120 is attached on the hub 16, and when the installation portion 120 is attached on the hub 16, the installation portion 120 as assembled is outwardly protruding from the hub 16 of the damper pulley 10.

In particular, the installation portion 120 includes a coupling flange 123 coupled to the hub 16 of the damper pulley 10, a first cylindrical portion 121 outwardly extending from the coupling flange 123, and a second cylindrical portion 122 disposed in parallel inside the first cylindrical portion 121.

As the coupling flange 123 is coupled to one surface of the hub 16 through a bolt or welding, the installation portion 120 may be integrally coupled to the damper pulley 10.

The first cylindrical portion 121 may extend in an axial direction of the pulley 10 from the center of the coupling flange 123 by a predetermined length, and the second cylindrical portion 122 is disposed in parallel to the first cylindrical portion 121 and radially spaced apart from the first cylindrical portion 121 by a predetermined gap (i.e., a space between an inner circumferential surface of the first cylindrical portion and an outer circumferential surface of the second cylindrical portion).

A plurality of strain gauges 111 are installed on an outer circumferential surface of the first cylindrical portion 121 in a circumferential direction.

One end of the first cylindrical portion 121 and one end of the second cylindrical portion 122 are connected through a connection portion 124, and a boss 125, to which the crank shaft of the engine 1 is coupled, is provided at the other end of the second cylindrical portion 122.

Through the configuration of the installation portion 120, torque generated between the crank shaft of the engine 1 and the belt 50 is transmitted from the second cylindrical portion 122 to the first cylindrical portion 121 and the coupling flange 123 through the connection portion 124 in a direction of T indicated by the arrow in FIG. 3. Thus, the strain gauge 111 installed at the first cylindrical portion 121 may precisely gauge strain due to torque transmitted from the damper pulley 10, thereby precisely detecting torque of the damper pulley 10.

In particular, a thickness t1 of the first cylindrical portion 121 may be formed to be smaller than a thickness t2 of the second cylindrical portion 122. Thus, since the strain gauge 111 is installed at the first cylindrical portion 121 having a relatively small thickness t1, the strain gauge 111 may precisely detect strain and torque of the damper pulley 10.

The plurality of strain gauges 111 may be installed as having a full bridge structure on an outer circumferential surface of the first cylindrical portion 121, to thereby more precisely detect strain or torque of the damper pulley 10.

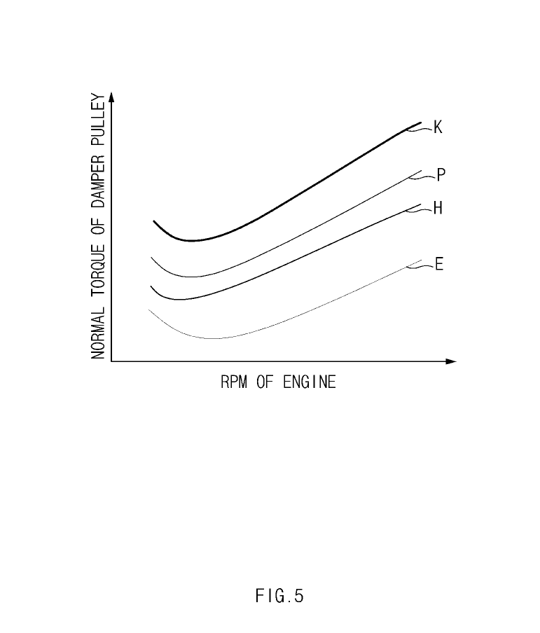

FIG. 5 is a graph illustrating normal transmission torque of the damper pulley 10 according to selective operation modes of a plurality of vehicle accessories and an RPM of the engine based on the assumption that the plurality of vehicle accessories include a water pump, an alternator, and an air-conditioning compressor.

In FIG. 5, line K represents normal torque of the damper pulley 10 in a first operation mode in which all of the water pump, the alternator, and the air-conditioning compressor operate.

Line P of FIG. 5 represents normal torque of the damper pulley 10 in a second operation mode in which the water pump and the alternator operate.

Line H of FIG. 5 represents normal torque of the damper pulley 10 in a third operation mode in which the water pump and the air-conditioning compressor operate.

Line E of FIG. 5 represents normal torque of the damper pulley 10 in a fourth operation mode in which only the water pump operates.

When torque detected in the damper pulley 10 in each of the operation modes of the vehicle accessories by the torque detection unit is outside a range of the normal torque illustrated in FIG. 5, whether the vehicle accessories have a fault may be diagnosed in time.

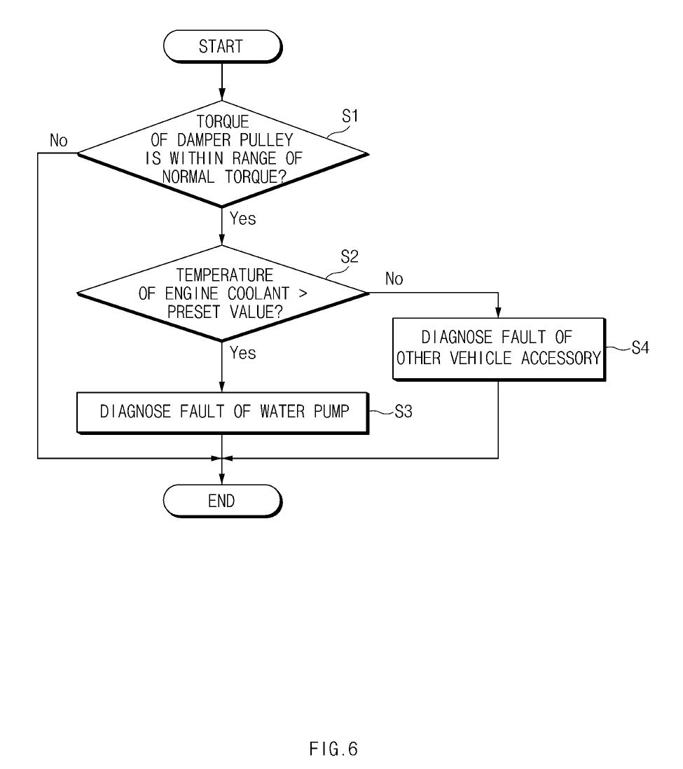

FIG. 6 is a flow chart illustrating a fault diagnosis method for vehicle accessories according to the present disclosure.

As illustrated in FIG. 6, torque of the damper pulley 10 is detected by the torque detection unit 110, and it is determined whether the detected torque of the damper pulley 10 is within a range of normal torque in operation S1.

When the detected torque of the damper pulley 10 is outside the range of the normal torque, it is determined whether a temperature of an engine coolant is higher than a preset value (which is appropriate for cooling the engine) in operation S2.

When the temperature of the engine coolant is higher than the preset value, the fault diagnosis part 115 diagnoses that the water pump has a fault and warns about it in operation S3. Here, since the belt 50 or the tensioner 60 may also have a fault due to the fault of the water pump, and thus, a fault of the belt 50 or the tensioner 60 may also be diagnosed.

When the temperature of the engine coolant is lower than the preset value, the fault diagnosis part 115 diagnoses a fault of a vehicle accessory (for example, the air-conditioning compressor or the alternator) other than the water pump and warns about it in operation S4.

As described above, according to the exemplary embodiments of the present disclosure, by monitoring torque transmitted from the vehicle accessory pulleys of the vehicle accessories to the damper pulley as a driving pulley of the vehicle accessory driving device in real time, a fault of the vehicle accessories may be promptly and effectively diagnosed.

As described above, according to the exemplary embodiments of the present disclosure, since the strain gauge is installed at the damper pulley, transmission torque of the damper pulley may be precisely gauged, and in particular, since the strain gauge is installed in the cylindrical installation portion installed to protrude outwardly from the damper pulley such that it is not affected by tensile force of the belt, measurement precision of torque may be further enhanced.

What is claimed is:

1. A fault diagnosis apparatus for vehicle accessories, the fault diagnosis apparatus comprising:
a damper; and
a torque detection unit installed at the damper pulley and configured to detect a torque of the damper pulley in real time.

2. The fault diagnosis apparatus according to claim 1, wherein the torque detection unit comprises at least one strain gauge installed at the damper pulley and configured to gauge a strain of the damper pulley.

3. The fault diagnosis apparatus according to claim 2, wherein the torque detection unit further comprises a fault diagnosis part connected to the at least one strain gauge,
wherein the fault diagnosis part is configured to calculate the strain of the damper pulley gauged by the at least one strain gauge as a torque value.

4. A fault diagnosis apparatus for vehicle accessories, the fault diagnosis apparatus configured to diagnose a fault of at least one vehicle accessory by detecting a torque generated in a damper pulley when the at least one vehicle accessory is driven, the fault diagnosis apparatus comprising:
a torque detection unit including at least one strain gauge installed at the damper pulley to detect the torque generated in the damper pulley; and
an installation portion protruding outwardly from the damper pulley, the at least one strain gauge installed on the installation portion.

5. The fault diagnosis apparatus according to claim 4, wherein the installation portion is attached on a hub of the damper pulley so that the installation portion protrudes outwardly from the hub of the damper pulley.

6. The fault diagnosis apparatus according to claim 5, wherein the installation portion comprises a coupling flange coupled to the hub of the damper pulley, a first cylindrical portion extending from the coupling flange in an axial direction of the damper pulley, and a second cylindrical portion disposed inside the first cylindrical portion in parallel to the first cylindrical portion.

7. The fault diagnosis apparatus according to claim 6, wherein the first cylindrical portion extends from a center of the coupling flange, and the second cylindrical portion is radially spaced apart by a predetermined gap from an inner circumferential surface of the first cylindrical portion.

8. The fault diagnosis apparatus according to claim 7, wherein the at least one strain gauge is installed on an outer circumferential surface of the first cylindrical portion.

9. The fault diagnosis apparatus according to claim 8, wherein the at least one strain gauge is installed to have a full bridge structure on the outer circumferential surface of the first cylindrical portion.

10. The fault diagnosis apparatus according to claim 9, wherein a thickness of the first cylindrical portion is smaller than a thickness of the second cylindrical portion.

11. The fault diagnosis apparatus according to claim 10, wherein an end of the first cylindrical portion is connected to an end of the second cylindrical portion through a connection portion, and a boss is provided at other end of the second cylindrical portion.

12. A fault diagnosis method for diagnosing a fault of at least one vehicle accessory by detecting a torque generated in a damper pulley as the at least one vehicle accessory is driven, the fault diagnosis method comprising:
detecting a torque of the damper pulley;
comparing a temperature of an engine coolant with a preset value when the detected torque is outside a range of a normal torque; and
diagnosing a fault of a water pump among the at least one vehicle accessory when the temperature of the engine coolant is higher than the preset value.

13. The fault diagnosis method according to claim 12, further comprising:
diagnosing a fault of a vehicle accessory other than the water pump among the at least one vehicle accessory when the temperature of the engine coolant is lower than the preset value; and warning about the fault of the vehicle accessory.
